(19) United States
(12) Patent Application Publication
(10) Pub. No.: US 2009/0287726 A1
(43) Pub. Date: Nov. 19, 2009

(54) METHOD AND SYSTEM FOR SYNCHRONIZATION OF DATABASES

(75) Inventor: Martijn Verhoeven, Enschede (NL)

Correspondence Address: YOUNG & THOMPSON, 209 Madison Street, Suite 500, ALEXANDRIA, VA, 22314, US

(73) Assignee: MAG PRODUCTIONS HOLDING B.V., RW ENSCHEDE (NL)

(21) Appl. No.: 12/296,298

(22) PCT Filed: Sep. 18, 2006
(86) PCT No.: PCT/NL06/50227

§ 371 Date: Oct. 7, 2008

(30) Foreign Application Priority Data
Apr. 7, 2006 (NL) 1031541

(51) Int. Cl. G06F 12/00; G06F 7/00

(52) U.S. Cl. 707/101; 707/203; 707/201; 707/3; 707/E17.044

(57) ABSTRACT

The invention relates to a method for synchronization of source data sets of a source database stored on a source system with representative target data sets in a target database database database stored on a target system, the source data sets being of a first type and the target data sets being of a second type. The source data sets are compared with the previous source data sets to obtain difference source data sets of the first type. The difference source data sets are transformed into transformed data sets of the second type and supplied to the target system to enable updating of the representative target data sets. Preferably, the transformation is performed via data sets of a third type, which allows to implement external business generation. To add fully transparent a new source of target database to a business information system using the method only the conversion from data type of the new source database to data sets of third type and/or conversion from data sets of third type to data type of target database has to be developed.

### FIELD OF THE INVENTION

The present invention relates to a method for synchronization of source data sets of a source database with representative target data sets in a target database stored on a target system. The invention further relates to a computer program product comprising computer executable instructions and a computing system for synchronization of source data sets of a source database with representative target data sets in a target database.

### PRIOR ART

Today any company, great or small, has some form of automation. Companies would like to grow and they seek companionships with other companies in order to increase their market and profit. Organizations invest in internationalization, spreading all over the world. Their information technology is asked to follow the growth and integration of data around the world.

If two large companies merge into one organization and both organizations had their own information technology system, problems arise with their technology system. Each company has their own database applications, for example stock control application, financial application or any other administrative application with a database connected to it. If the information in those databases had to be shared over the whole new company, huge problems arise. The application and data are not ready to exchange data. If each company would like to use their own application, application interfaces had to be made to enable the exchange of data. Furthermore, the data content could be different, for example the format or units used. To overcome this incompatibility of data special interfaces had to be designed to enable the exchange of data from one database system to another. The incompatibility problems increases exponentially if a third database application is added to the company. A dedicated interface to each application has to be made to enable the exchange of data between the three systems.

Another solution to overcome those problems is to continue the new company with only one of the two database applications or a new application. However, this has the disadvantage that at least a part of the employees has to be trained to use the adopted or new application.

Nowadays, there is a need to share business information to improve the business performance. On the internet web-services are available to book your own holiday accommodation. A customer can select his destination and further requirements, such as number of persons, arrival and departure date, and perform a search for available accommodations. Preferably, the accommodation of all the suppliers provide their information to be available in such a web-service. However, each supplier, in this example travel agency, has his own database application, with their specific database format. Each application is running independently, which means that an accommodation could be booked by the agency in their database application and be booked via the web-service. This requires that the data in the system stays consistent. Otherwise, the search result on the web-service could provide accommodations which are not available anymore.

The above problem could be solved by searching in the database of the agencies to find available accommodations. However, if the connection between the database application of the agency and the web-service is temporarily interrupted, the user could not find any accommodations of said agency. Furthermore, searching via an internet connection in a non-locally available databases could be relatively slow. Preferably, all information of all agencies is stored locally in one database. However, the information in the respective databases could be incompatible.

Generalizing, database applications were designed with specific aims, goals, means and experiences, resulting in an application fitting to specific company goals. However, the database applications are not designed for an expanding company. The applications and data are not ready for exchange and cooperation with other applications, nor are they compatible. The data is there, but can not easily be exchanged or integrated with other data or database systems.

In supply chain and value constellation management there is a need to use actual data from others and to integrate the data in its own database. As each company in the chain normally has its own designed applications, and cooperates with more then one company, it is not an option for a company to migrate to the application of another company or to match its database structure. This will cost a lot of effort and would result in incompatibility problems with the other companies.

### SUMMARY OF THE INVENTION

The present invention seeks to provide an improved method for synchronization of source data sets of a source database stored on a source system with representative target data sets in a target database.

According to the present invention, the method comprises:
(a) retrieving source data sets;
(b) retrieving previous source data sets from a first memory;
(c) comparing the source data sets with the previous source data set to obtain difference source data sets of the first type;
(d) replacing in said first memory the previous source data sets with the source data sets;
(e) transforming the difference source data sets into transformed data sets of the second type;
(f) supplying the transformed data sets to the target system to enable updating of the representative target data sets.

The invention is based on the recognition that nowadays companies have the desire to cooperate with each other and share their data with each other, but cannot exchange their data as each company has their own database system. Furthermore, to perform fast, secure and reliable access to each others data the data from one system should be locally available in the other system. As the access to data of the other system is not dependent on the communication link between the systems, the access is fast and reliable. However, synchronization of the data is needed to ensure that for example an accommodation from another company will not be booked twice. To enable exchange of data an interface has to be developed to transfer data from one database to another. This means that if data has to be exchanged between two database systems, two interfaces has to be designed, one interface to exchange data from the first database to the second database and one to exchange data from the second database to the third. If a third company with their own database want to join the cooperation between the two companies, four new interfaces has to be designed. If a fourth company would like to join the cooperation, six new interfaces have to be designed, and so on. Thus, the more companies would like to cooperate with each other, the more interfaces have to be designed, which makes it finally not worthwhile to share the data of a new company. Furthermore, to keep the data synchronized is even a more difficult task.

To overcome this problem a solution is provided that synchronizes content of a source database with representative content of a target database which can easily be extended with data from other databases and which provides to one or more target databases only the necessary data to synchronize to corresponding data in the target database.

According to the invention firstly, the different data sets of the current source database with a previous version of the database have been determined. Secondly, only the different data sets are transformed into a format suitable to update the target database on a target system. This method reduces the amount of data to be transformed, transferred and processed on the target system as only the data sets which are updated, added or deleted have to be processed. Consequently, the time to synchronize the content of the target database with the content of the source database is greatly reduced.

In a further embodiment of the invention the method performs repeatedly the actions above. This feature enables to guarantee that the content of the target data set representative for the content of the source database will not be outdated.

In a further embodiment of the invention, the transforming action (e) comprises:
(e1) converting the difference source data sets into intermediate data sets of a third type;
(e2) retrieving data from the intermediate data sets to obtain the transformed data set.

This feature enables easy application of external business generation (EBG). This means that with relatively little effort the data of another database can be integrated in an already existing system which synchronizes the content of several different databases on a target database or to provide the content of said several different databases to synchronize said content in a new target database. Only one converter has to be developed to integrate the difference source data sets into the content of the other database in such a system and to supply the content to any target database retrieving the content via said system. Furthermore, only one new retrieving procedure has to be developed to enable supply of the source databases to a new target database.

In a further embodiment of the invention the data sets of the third type comprises data fields for storing a representation of at least a part of the data fields of a data set of the first type and data fields representative for data fields of a data set of the second type. This feature allows reducing the amount of data to be stored in the system performing the method according to the invention. Only data representative of data to be necessary in the target databases are stored in the data sets. Thus not all data fields from a source data set have to be stored in the intermediate data set.

In a further embodiment of the invention the data sets of the third type comprise a data field with content being a copy of content of a data field of the source data set and/or a data field with content being a representation of said content of said data field of the source data set. This feature allows optimizing further the amount of data to be stored in a system performing the method, by storing the data set in a format most suitable to provide content to target databases to enable synchronization with source databases.

In a further embodiment of the invention comparing (c) comprises:
(c1) retrieving a new data set of the first type from the source database;
(c2) searching for a corresponding previous data set stored in a second memory;
(c3) if a corresponding previous data set is not found in (c2) storing the new data set from the source database in the second memory;
(c4) if a corresponding previous data set is found in (c2) perform:
(c4a) supplying a difference source data set obtained from the new data set if the new data set differs from the corresponding previous data set; and
(c4b) removing corresponding previous data set from second memory.

These features allows to perform very efficient comparison of data set from a huge database, wherein the order in which the data sets will be retrieved is not predefined but more or less random. Only data sets that have not been found will be in the second memory. At the end of the comparison, the second memory comprises the new data sets and the data sets that have been removed from the source database.

In a further embodiment of the invention comparing (c) comprises
(c5) retrieving a previous data set of the first type from the previous source database;
(c6) searching for a corresponding new data set stored in the second memory;
(c7) if a corresponding new data set is not found in (c6) storing the corresponding previous data set from the first in the second memory;
(c8) if a corresponding previous data set is found in (c6) perform:
(c8a) supplying a difference source data set obtained from the new data set if the new data set differs from the corresponding previous data set; and
(c8b) removing corresponding new data set from second memory.

These features in combination with the previous features allows to perform the retrieving and searching of new data sets and previous data sets independently from each other. The second memory comprises only the data sets for which a corresponding data set has not been retrieved. In this way the number of data sets in the second memory can be reduced, which reduces the time to detect that a specific data set is retrieved from the source data base with actual data as well as the previous source data set with corresponding previous data.

In a further embodiment of the invention, the method comprises
(g) controlling the actions (a) and (b) in dependence of the number of retrieved new source data sets and the number of retrieved previous source data sets.

This feature allows to reduce further the storage capacity of the second memory. It has been found that the retrieving order new data sets and previous data sets is not similar but more or less equivalent. By controlling the number of retrieved data sets from the source data sets and previous data sets, the storage capacity of the second memory could be further reduced.

In a further embodiment of the invention, a source data set comprises a static data part and a dynamic data part, and the actions (a)-(f) being performed independently for the static data part and the dynamic data part. This feature enables to reduce the time to perform the method. Static data, such as type of accommodation, number of beds, pet allowed, varies almost never. Whereas, dynamic data, such as reservations of said accommodation could vary daily. According to the invention the static data part of the database could be synchronized for example weekly, whereas the dynamic date is synchronized at least daily. This allows to process only a part of the content of the data base and not the full database.

In a further embodiment of the invention, a difference source data set corresponding to a dynamic data part comprises a status indication flag, and wherein transforming (f) of a difference source data set corresponding to a dynamic data part is performed under control of the status indication flag.

These features allow to reduce the number of difference source data set to be supplied to the target system. As the dynamic data part of the target database is updated more frequently then the static data part, a dynamic data part of the data set could be supplied to the target system before the static part of the data set. The dynamic data part can only be integrated in the target database when the static data part is available in the target database. The status indication flag is used to indicate that the static data part is not yet available in the target database. The dynamic data part of a data set with status not yet available will be supplied to the target database after new static data parts have been supplied to the target database. In this way, the amount of data to be supplied to the target system is reduced, which decrease the throughput time to perform a synchronization.

The present invention can be implemented using software, hardware, or a combination of software and hardware. When all or portions of the present invention are implemented in software, that software can reside on a processor readable storage medium. Examples of appropriate processor readable storage medium include a floppy disk, hard disk, CD ROM, memory IC, etc. When the system includes hardware, the hardware may include an output device (e. g. a monitor, speaker or printer), an input device (e. g. a keyboard, pointing device and/or a microphone), and a processor in communication with the output device and processor readable storage medium in communication with the processor. The processor readable storage medium stores code capable of programming the processor to perform the actions to implement the present invention. The process of the present invention can also be implemented on a server that can be accessed over the telephone lines.

Some of the actions of operation described below are found in prior art enhanced map generators. However, the prior art enhanced map generators do not use geo-coded image sequences to obtain the information to enhance a map as described below.

### SHORT DESCRIPTION OF DRAWINGS

The present invention will be discussed in more detail below, using a number of exemplary embodiments, with reference to the attached drawings, in which

FIG. 1 is a simplified block diagram of an organization using the invention.

FIG. 2 is an other simplified block diagram of an organization using the invention.

FIG. 3 is a flowchart describing the method according to the invention for synchronizing static data and dynamic data.

FIG. 4 is a flowchart describing the method according to the invention for synchronizing static data and dynamic data.

FIG. 5 is a block diagram of an exemplar hardware system for implementing an the method according to the invention.

### DETAILED DESCRIPTION OF EXEMPLARY EMBODIMENTS

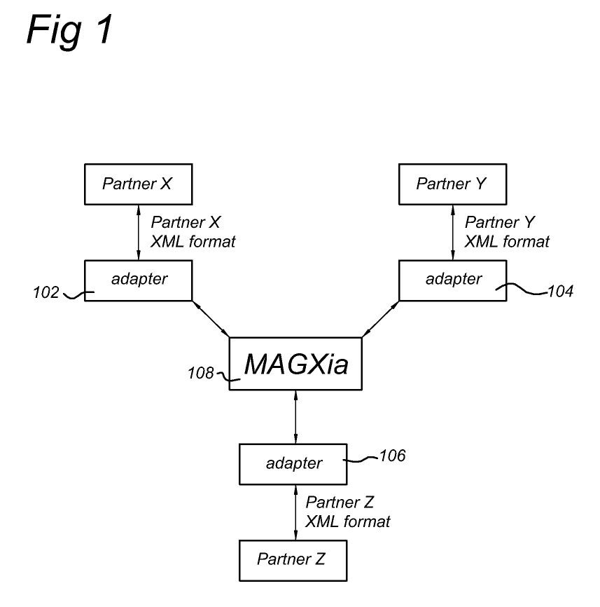

FIG. 1 is a simplified block diagram of an organization using method according to the invention. At a high level, according to the invention the method exchanges data from one organization to another. For example, partner X, Y and Z would like to share their database information with each other. Each partner could have his own IT-infrastructure with partner specific database system. It is even possible that content of a data field in the database of partner X has to be transformed to representative content to be stored in a data field in the database of partner Y. For example, a brewer of beer has in his database a field corresponding to the number of beer crates with 24 bottles on stock, whereas a supermarket has in his database the number of bottles on stock. If the brewer and supermarket would like to share this information in their respective databases, the number of crates has to be transformed into number of bottles and the number of bottles has to be transformed into number of crates. This transformation is performed in an adapter 102, 104, 106. Furthermore, the partners X, Y and Z, would like to have the database information of the partners in their own database system, to ensure that they can also make use of the database information in the event a system of the other partner is down or not reachable due to communication problems. Furthermore, the locally availability of the data of the other partners has the advantage that the data can obtained very quickly.

According to the invention a partner supplies at request for synchronization datasets to an adapter 102, 104, 106. The database system of this partner is regarded to be a source system with a source database. It is commonly known that items can be stored in a database in datasets, wherein a data set comprises data fields. The data sets have a predefined data structure. The data sets could be transmitted to the adapter in any suitable data format. Preferably, the data is sent in Extensible Markup Language (XML), which is used for describing data in a structured text format. In the embodiments described in this application the data format transmitted to the adapter is in XML format. The invention is not limited to this data format, for example the data could be in Comma Separate Value (CSV) data format. The data set could also be obtained via Web Services. If the source data sets are not retrieved in XML format, the source data sets are converted into XML-format. The source data sets in XML format are supplied to processing unit 108.

Processing unit 108 compares the retrieved source data sets, in XML-format, with previous source data sets. The previous source data sets were stored in a memory during the previous request for synchronization. The source data sets which comprise a difference with the previous data sets are stored as difference source data sets. A difference could be that a new data set has been detected in the source data base, the content of a data field of a source data set has been changed or a source data set has not been found in the previous source data set. The thus obtained XML file with difference source data sets could be regarded to be an incremental backup. An incremental backup is a kind of backup that copies all files which have changed since the date of the previous backup. According to the invention an incremental XML-file is generated with data sets which have changed since the data of the previous request for synchronization.

In the event, partner Z would like to synchronize data sets in his database representative for datasets in partner X, adaptor 106 retrieves from the incremental XML file the difference source datasets to supply the data sets to the target database of partner Z. If the data sets in the incremental XML file comprise data field that could not be used in the database of partner Z, the adapter 106 could be arranged to supply only the data fields of the difference source data sets, that could be used in the target database for synchronization.

The basic idea of the invention is that for synchronization content of a target database, wherein said content is representative for content of a source database, firstly the differences of content in the source database are determined, and secondly the differences are used to update the target database.

If the format of the datasets of the difference source data sets is such that comprises the necessary data fields to update the databases of all the partners, this has the advantage that if a new partner would like to join, only one adapter has to be developed. One part of the adapter performs the interfacing to add the necessary incremental information to the difference source data sets. Another part of the adapter performs the interfacing to retrieve the necessary information from the difference source data sets to enable synchronization of the content of the database of the new partner with the content of the databases of the other partners.

Preferably, the processor unit 108 keeps control over the synchronization of the databases and determines when a synchronization cycle has to performed. A synchronization cycle comprises basically two stages. In the first stage, firstly, all databases are requested to supply the datasets in their respective databases to the corresponding adapter 102, 104, 106. Secondly, all changed datasets after the previous request are determined and stored in one database, in our case an intermediate XML-file comprising all the difference source data sets. In the second stage of the synchronization cycle, the processor unit 108 initiates the adapter 102, 104, 106 to retrieve the necessary information for the intermediate XML-file and to supply said information to the corresponding database to enable synchronization of said database with the corresponding information of the other partner databases. It might be clear, that by means of this method each of the partners X, Y and Z can increase their overall business performance by integrating the “almost real-time” business information of the other partners in their own database or IT-system. Having knowledge of the business information of a contractor, could be a decisive factor for a new client to go into business with a company. In that event the business of the company, the business of the contractor increases and consequently the business of all together partners increases. This is what we call External Business Generation, enlargement of the own business by integration of external value chain or value constellation information from the partners/suppliers network of IT-system.

It should be noted that the format of the data sets in the intermediate file is such that it gives a total representation of all partner data and is suitable to provide data to all partners to update their local databases with data from the partners. Therefore, if a new partner will join, and the partner has some interesting data fields with new type of information in his data sets which information improves the application of at least one partner, the format of the datasets in the intermediate file has to be updated. Furthermore, as the format of the data sets in the intermediate file is suitable to represent the relevant data of all partners, the intermediate file can be made as a large sequence of modifications of all data set of all partners. In an embodiment of the invention the processing unit 108 retrieves sequentially the source data sets of the partners and generates a combined intermediate file. From said combined intermediate file the required data sets are selected to enable synchronization of a partners target database.

The following example is illustrative how external business can be generated. Imagine being at work on Friday afternoon, feeling ready for the weekend. Dreaming about a holiday somewhere in Europe, in some nice place, close to a forest and a fireplace in the living room. Looking for this place on the internet, you arrive at www.vakantiehuisje.nl.

There is a huge amount of holiday cottages and houses available for rent. You can look for houses with a fireplace, which have one double bedroom, two single rooms and two bathrooms, one with a bath. Also, with a click of a button, houses can be checked for availability, sorted by price. The best part: it can be booked online!

The vakantiehuisje.nl site provides all the above facilities. This requires a rather large and up-to-date databases, easily searchable by a lot of different criteria. Normally, all these houses where administrated by the people who owned the houses. However, this limits the number of online houses, since large companies like Wolters Reisen in Germany, EuroRelais and others have a vast amount of other houses already available. These companies have their houses stored in their own databases, in their own systems. By means of the method according to the invention, they provided vakantiehuisje.nl access to all their data, preferably in XML format. The method seamlessly integrates all these XML data files into a vakantiehuisje.nl specific incremental XML format.

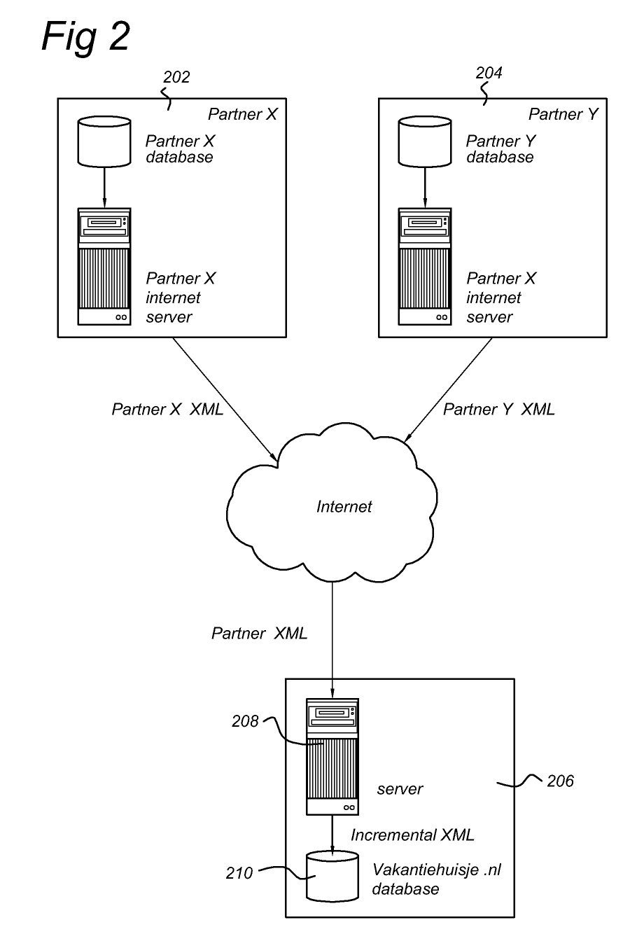

The good thing about the incremental XML format is, that only differences between the old and new data from the partners are generated. This relieves the system and greatly decreases the amount of resources required. This incremental vakantiehuisje.nl XML format is again integrated into the local databases. FIG. 2 gives a visual representation of this process.

The invention enables having over a few thousand holiday houses added and available instantly, continuously and automatically kept up-to-date. With the method according to the invention, a company can integrate and convert XML from any format to any other format, allowing seamless integration of systems and data which could not have been easily possible without the invention.

In FIG. 2 the source systems of the partners 202, 204 comprises the adapters 102, 104 to convert the information from their respective databases into a partner specific XML-file. The partner specific XML is transferred via the internet to the target system of vakantiehuisje.nl. The target system comprises a server 208 which comprises the processor unit 108 of FIG. 1. The server 208 supplies the incremental XML file, comprising the necessary data to enable updating of the vakantiehuisje.nl database 210. In FIG. 2 the systems are connected by means of the internet It should be noted that any suitable connection to obtain the partner XML-file could be used. Examples of a suitable connection are telephone line, cable connection, satellite connection. Instead of XML, any other commonly used standard format for data exchange could be used. The server 208 does not necessarily be part of the target system. The server 208 could supply for example the incremental XML file via the internet to a target system which comprises only the application for the vakantiehuisje.nl site and the necessary target database. As the target database comprises the necessary information from the holiday houses of the partners, a search can be performed quickly and reliable. Quickly, as no request for search has to be performed on the databases of the partners. Reliable, as no connection has to be made to a source system of a partner to perform a search. A search can be performed in all holiday houses of the partners even if there is a connectivity problem with any of the partners. These two features, enlarge the possibility that a holidaymaker visits the site of vakantiehuisje.nl and books his holiday via vakantiehuisje.nl as he probably would always find a holiday house according to his requirements. The visit at least increases the chance that the holidaymaker books a holiday house of vakantiehuisje.nl or at least increases the overall business performance of all the partners together, as due to the huge quantity of holiday houses a holidaymaker would find always a holiday house according to his requirements.

All the partners in the examples given above may supply different files at different intervals with completely different structures and contents. The adapters 102, 104, 106, are a sort of adaptation layer, which contains partner specific code which in turn translates the partner data to one common interface format. From this interface onward, no partner specific code is required. This enhances modularity and ease of implementation of the invention.

When more partners come into play, a partner specific adaptation module has to be developed which transforms the partner specific data into the common interface format.

The partners could have data which is specified in different languages. Furthermore, the partners could be domiciled in different countries. Therefore, the common interface allows to have text which has to be presented by different partners to be stored in different languages.

The process illustrated in FIG. 2 could also be used for providing web-application which provide material of comparison of products, such as insurances. Insurance companies will provide the term of provision of insurance and the corresponding insurance premium. At the web-site, customers can search for insurances matching their needs and subsequently request to provided the differences between the insurances that match. In this way they can compare very easily insurances and select the most suitable insurance.

In general, partners could supply two types of data: static and dynamic data. Static data doesn't change frequently, whereas dynamic data could change very often. In the example of vakantiehuisje.nl, static data is the data related to descriptive information about a holiday house, such as location, size, number of beds, parking places, data about countries regions, available rental periods, etc, and dynamic data comprises for example the availability of the holiday house, the price per period. The dynamic data of a holiday house changes with each reservation or cancellation. It should be noted that the static data part and dynamic data part of an object, i.e. a holiday house, form together one data set.

In an embodiment of the invention these types of data are split while processing partner data. Splitting relieves the system performing the method according to the invention of unnecessary resource consumption. Resource consumption could be processing power, transmission bandwidth, memory usage. As static data hardly ever changes, static data have to be checked for updates to enable synchronization on the target system less frequent then dynamic data. Preferably, the dynamic data is checked at least one time a day, whereas the static data could be checked once week.

However, there is a problem when handling static data and dynamic data independently and differently, especially at different times and/or different intervals. A dynamic data part of a data set is always related to a static part of a data set.

As an example, suppose the static data is processed weekly, while dynamic data is processed daily. Just after static data has been processed, the data changes at the database of the partner, for example a new holiday house has been added to his database. The following days reservations have been made, resulting in a change in the dynamic data part of said holiday house. This dynamic data part is based on the newly created corresponding static data part.

When the dynamic data part is parsed the next day, it will contain information to be used later on to relate to a static data part, which is yet not available in the target database. Information is provided to the target database which can not be integrated in the target database.

This dynamic data part may not be dropped, since it may contain information which has to be used later on to relate to static data. It is also not efficient to request at the moment a dynamic data part without corresponding static data part is detected in the target database, to provide first the corresponding static data part, because the dynamic part has to wait for this. To provide the static data part, the entire static data parts of the partner database have to be retrieved and processed. This requires quite a resource consumption.

A solution has been found by setting the dynamic data parts without corresponding static data part aside. In an embodiment of the invention each dynamic data part of the difference source data sets has a corresponding data field indicating whether said dynamic data set is integrated in the target database. If the dynamic data set is not integrated the indication will be non-committable incremental data. The resulting set of this non-committable dynamic data part is called “the update pool”. This construction makes parsing of already parsed data unnecessary.

The only thing that has to be taken care of is the integration of the pool when new static data comes available. This is not a big problem. After parsing and reintegrating static data, another job can be started to integrate the update pool by supplying the difference source data sets marked as non-committable incremental data to the target database. Preferable not only the data sets marked as non-committable incremental data are supplied to the target database but also new difference source data sets which have never been send to the target database are supplied.

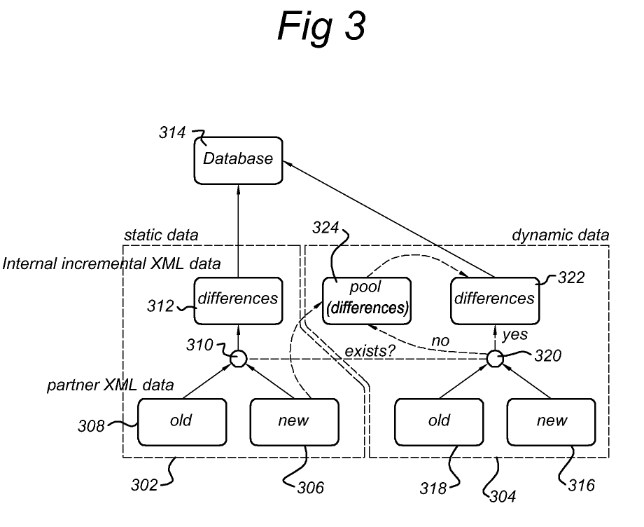

FIG. 3 shows a flowchart describing the method according to the invention for synchronizing static data and dynamic data. The flowchart comprises two parallel paths. One path 302 for synchronizing the static data and another path 304 for synchronizing the dynamic data. In path 302, block 306 represents the retrieval of the static part of the source data sets. In the present description the source data sets are in the from of XML data. Block 306 could comprise the conversion from the partners database format to the XML format. Block 308 represents the retrieval of the previous source data sets from a first memory. Not shown in the flowchart is the step to store the source data sets in the first memory to become the previous data sets for the subsequent synchronization cycle. In 310 the new source data sets and the previous source data sets are compared. Block 312 represents storing the data sets that differ as difference source data sets. Furthermore, 312 represents transforming the difference source data sets into transformed data sets and supplying the transformed source data sets to the target database to enable the content of the target database with the determined differences. The transformed source data sets are of a second type, and comprises those data fields from a data set that are suitable to update data fields of a data set in the target database. Block 314 represents the integration of the transformed data sets in the target database for both static data parts and dynamic data parts.

The new source data sets could be of a first type and are converted in block 312 to an intermediate format of a third type prior to storage in a memory. A data sets of the third type comprises data field for storing a representation of at least a part of the data field of a data set of the first type. Furthermore, a data set of the third type comprises data field representative for data field of the second type. For example, the source database of the first type comprises data fields indicating the number of bunk beds, double beds and single beds for adults and children respectively. A first target database needs data about the number of adults and children beds, whereas a second target database needs to know the number of single beds and double beds. In the intermediate format the data set could comprise enough fields to store all possible representations of beds to used in source and target databases. This would make it possible that the content of fields of a transformed data sets could directly be copied from the intermediate data sets. However, to save resources to store the intermediate data sets it is more efficient to have only those data fields that are representative for data fields of the target database. This could mean that the content of a data field of a transformed data set has to be derived from the content of at least one data field of an intermediate data set. For example, the intermediate data set comprises data field for the number of bunk beds and double beds, whereas the target data base has a field for the number of sleeping places for adults. In this case the number of sleeping places is derived from the number of bunk beds and double beds.

In path 304, block 316 represents the retrieval of the dynamic part of the source data sets. Block 316 could comprise the conversion from the partners database format to the XML format. Block 318 represents the retrieval of the dynamic part of previous source data sets from the first memory. Not shown in the flowchart is the step to store the source data sets in the first memory to become the previous data sets for the subsequent synchronization cycle. In 320 the dynamic part of new source data sets and dynamic part of the previous source data sets are compared. Block 322 represents storing the dynamic parts of data sets that differ as difference source data sets. Furthermore, block 322 represents transforming the difference source data sets into transformed data sets and supplying the transformed source data sets to the target database to enable the content of the target database with the determined differences. The transformed source data sets are of a second type, and comprises those data fields from a data set that are suitable to update data fields of a data set in the target database. Block 324 represents the integration of the transformed data sets in the target database for both static data parts and dynamic data parts.

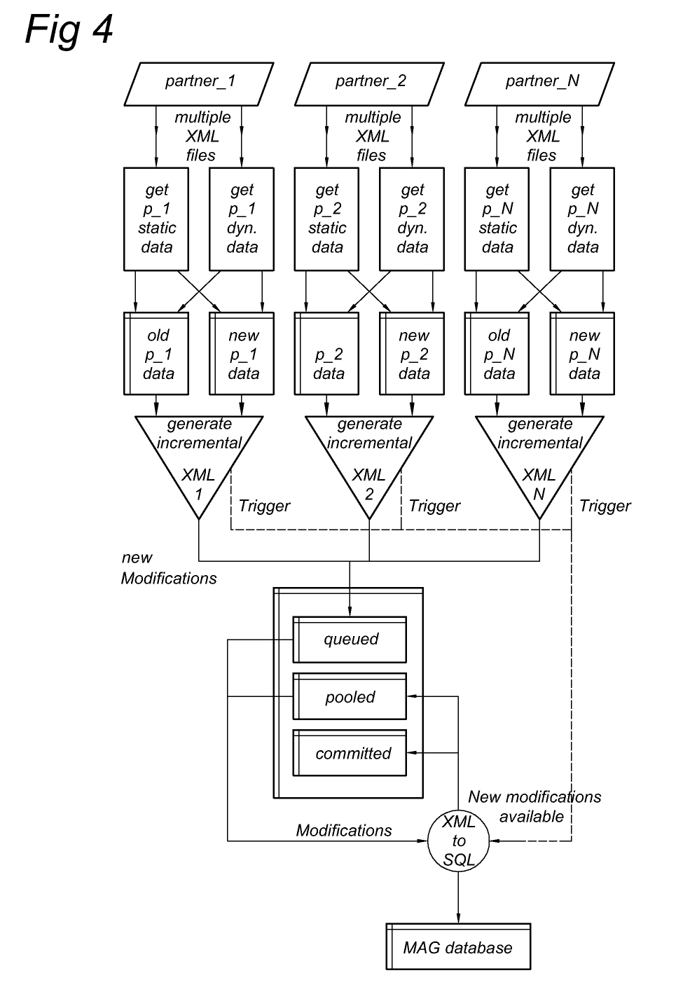

The dotted lines in FIG. 4 illustrate schematically an embodiment of the interaction needed to update correctly dynamic data in a target database. The dotted line between 320 and 310 indicate that for a dynamic part of a new data set has to be checked whether the static part of said new data set is already parsed to or integrated in the target database. If not, the dynamic part of said data set is added to a pool of data sets. This is illustrated by the dotted arrow from 320 to block 324. If true, the dynamic part is added to the dynamic parts of data sets to be supplied to the target data base. This is illustrated by the dotted arrow from 320 to block 322. Block 324 represents the storage of dynamic data sets as non-committed data sets. As soon as the corresponding static data part of said data set is retrieved from the source data base and is supplied to the target database, this is signaled to 324 which takes care that the dynamic part will be part of the differences of dynamic data sets to be supplied to the target database. This is illustrated by the dotted arrows between block 306 and block 324, and block 324 and 322 respectively.

FIG. 4 is a flowchart describing another embodiment of the method according to the invention for synchronizing static data and dynamic data. Different partners provide multiple different XML files. Some files contain static data, other contain dynamic data. These are retrieved at a set time, usually right after the partner has updated them. These files are stored as new data, just after moving the previous new data to the old data storage.

From this old and new data, for each partner separately a collection of incremental XML modifications is generated for both the static and dynamic data, only at different intervals. This data from all partners is merged into one set of modifications. These modifications are in turn committed into a database in a kind of like XML to SQL, Structured Query Language, translation.

First the modification set will be explained. After that, an overview of the threads within the XML Integration Application, or XIA for short, will be given. This is the application that takes care of the entire integration process.

The set of modifications to be committed is stored in a database. A modification is an XML string with a marker, indicating whether this modification is:
“queued”, meaning that it is waiting to be supplied to the target database;
“committed” meaning integrated in the target database and ready for removal;
“pooled”, meaning for later commission because some related data is not available yet in the target database.

According to this embodiment a dynamic part of data set a source data base will cause the following data processing step in his life cycle. Firstly, a new data set will be generated in partner application and stored in the source database. During the next dynamic part update cycle the new dynamic part is retrieve from the source database. As said dynamic part is new, it will be added to the modification or intermediate data sets. The marker corresponding to said dynamic part will be set to “queued”. Upon request all data sets with status queued are supplied to the target database. The application performing the integration of the content of the data sets in the target database, will report XIA whether a data set is integrated in the target database or could not be integrated due to non-availability of the corresponding static data part in the target database. XIA will set the marker of an intermediate data set to “committed” if the data set is integrated and will set the marker to “pooled” if the data set could not be integrated. When the dynamic part is changed in the source database, the subsequent update cycle will detect the change in the data set and store the change in the intermediate database set. Upon request to update the target database, only the intermediate data sets with a marker queued will be supplied to the target database. As long as no subsequent update of the static part has been requested, the dynamic parts with marker pooled not be supplied to the target database. As soon as new modifications of static parts has been requested and detected, XIA will supply to the target database the dynamic parts of the intermediate data sets with both marker queued and pooled. If the application performing the integration detects that a dynamic part which had the marker “pooled” is integrated in the target database, the application will report to XIA that the dynamic part is integrated and subsequently XIA will set the marker to “committed”, otherwise the market of set intermediate database will be unchanged. The use of the marker enables to reduce to amount of data to be supplied to a target database.

The XML Integration Application will use threading to support multiple simultaneous tasks. For each task threads will be started. Because of this, all objects that could be used by multiple threads at the same time will have locking mechanisms installed to prevent threads from cluttering each other's data.

Some threads run forever, others only at certain moments. A short overview of all the threads. Permanently running threads: XIA which is main thread purely for handling signals and cleanup afterwards; scheduler for scheduling partner data handling; modification handler for handling the updates in the modification set. Temporarily running threads: janitor for cleaning the modification set or intermediate database; partner data handler for parsing partner data.

The XIA main thread deals with all the management functions surrounding the XML Integration Application. This includes the following list:

initializing the database connection;

initializing the context for other objects and threads;

initializing the sheriff;

starting up the other threads;

scheduling the janitor;

handling external signals;

cleaning up on exit.

The XML Integration application can be controlled through a number of signals. These signals and their function are documented in the following section.

The scheduler thread takes care of starting the temporary threads at set times. The database is first queried to find all the partners. For each partner, a respective config script is started so all the partner specific code can schedule itself for later execution by the scheduler. There is a respective config script for each partner as each partner generates by means an adaptor 102, 104, 106 a partner specific XML file.

It is further vital for each partner to be able to run some initializations code. This has two reasons. The first consists of the fact that at an early stage, errors in partner specific code can be detected at startup; not at a later scheduled time. Second, every partner specific part of code of the XML Integration Application knows best for itself when it should be scheduled again. For example the size of the source database determines the throughput time to perform a synchronization or update cycle.

A sequence of actions within the scheduler starts when a task is scheduled. At that moment, the newly scheduled task is put in the internal schedule, sorted ascending by execution time. After that, the delay until the next task is calculated and an alarm signal for delivery after this delay will be scheduled.

Upon reception of the alarm signal, the internal schedule is checked for tasks which should have been run or should run now. These tasks are executed in the order of their scheduled execution time in a separate thread. Executed tasks are deleted from the schedule.

Finally, the delay between the next task and the current time is checked. If this delay is small (less than two seconds or negative), the task is run in the same manner as in the previous paragraph. Otherwise, an alarm to be delivered after the calculated delay is scheduled again.

The modification handler thread waits for a trigger from the partner data handler to indicate modification availability. The modification handler then handles all modifications and marks them either ‘pooled’ or ‘committed’, depending on the result of the query. Another possibility is that the modifications are marked ‘partial’, because they need to be combined with modifications from other files before they are ready to be processed. Modifications marked ‘partial’ are stored with a bit-mask (>0) that, when AND-ed with all other ‘partial’ modifications for the same object, combines to 0 (zero) if all parts are available.

When large amounts of modifications are suddenly enqueued, it is undesirable that the modification handler causes a high load at a systems processor. That is why, at a very low level, the modification handler “takes a break” after handling each modification. This break is in the form of a short delay or sleep in which the handler does not require processing time from the system.

When the modification handler starts, it first tries to commit all the queued and if requested pooled modifications. After that, it will wait for an event. This event can indicate either that modifications just queued should be processed (a queue event), or that also the pooled modifications should be processed (a pool event). The latter can occur when partner data handler integrates modifications on static data which could be referenced by pooled modifications.

The janitor thread keeps the modification set clean. When modifications have been committed to the database, they remain in the set, but they are marked as “committed”. These modifications accumulate over time, which is why the janitor takes care of this. Committed modifications which have been committed over some time, p.e. one week, are deleted from the database. It might be clear that this period is configurable. The marker “committed” is suitable to verify whether the system is working properly. First, can be verified when a last modification in a source database has occur and secondly can be verified whether a modification is correctly integrated in the target database. A partner could require that the “committed” marker is used to verify the system. If the system is proved to work properly, the “committed” marker could be regarded to be superfluous.

The partner data handler threads performs some actions which are common for all partners. They all need to retrieve files and to process the data in said files. Retrieving files could be done in a partnerParser superclass, with just a URL specification as source and a destination to store the data. This saves a lot of coding for new partners.

All the threads described above need to be commanded or synchronized in some way. This is done via events. Every thread registers itself with the Sheriff, a special object which takes care of broadcasting events. A thread registers itself through a subscription and through this subscription, the thread notifies the Sheriff which events it wants to receive. The actual synchronization takes place through an event object which implements a basic lock mechanism using semaphores.

Once events occur, the Sheriff sends all the threads that have subscribed to this event a notification. A list of events with their description:

“alarm” used only for the scheduler to run the next task;

“dump” only for the scheduler to dump its schedule to a file;

“finished” used by threads to say that they have finished;

“pooled” new pool data has become available;

“queued” new queue data has become available;

“quit” terminate gracefully as soon as possible;

“reread” reload the configuration data;

“reschedule” reschedule the next alarm in the scheduler thread;

“threaddone” notification for threads that another thread has finished;

“warp” run the next task right now.

In view of the description above, the person skilled in the art knows how and when to use each of the events.

The invention is used to synchronize very large databases. Size of some giga bytes are not exceptional. It is commonly known that when the content of a large database has to be transferred from one system to another system, the order in which data sets will be transferred will vary. This is due to modifications in the content of the database, such as modification, addition or deletion of data sets. Therefore, a data set which was transferred during a previous transfer of the database at the beginning, could be transferred at the end of the transfer of a subsequent transfer of said database. The differences are clear after processing both the previous data sets and the new data sets. The order of the data sets is globally the same, but a percentage of data sets is transferred completely out of the previous order. Furthermore, it can only be decided that a data set has been removed from the database after all data sets from the source database have been processed. Furthermore, it can only be decided that a data set is a new data set when said data set is compared against all the old or previous source data sets. This process can be implemented straightforward this could mean that first all the previous source data sets of a target database are read in a data memory and subsequently in said memory is searched for a previous data set which corresponds to a newly received data set. It could happen that the newly received data set is found at the end of the data memory. Therefore, if the compare process is implemented straightforward, this will require a data memory with a size between the expected maximum size of the database and twice the expected maximum size. Furthermore, the searching will require a lot of processing power, as all the data sets in the data memory has to be verified to concluded that a data set could be regarded to be new.

To perform the comparing of databases more efficiently, a new approach has been implemented. The approach takes into account that the order in which the data sets are retrieved from the source database is globally the same. The implementation of the approach requires less resources to perform the comparison, such as computing power and data memory.

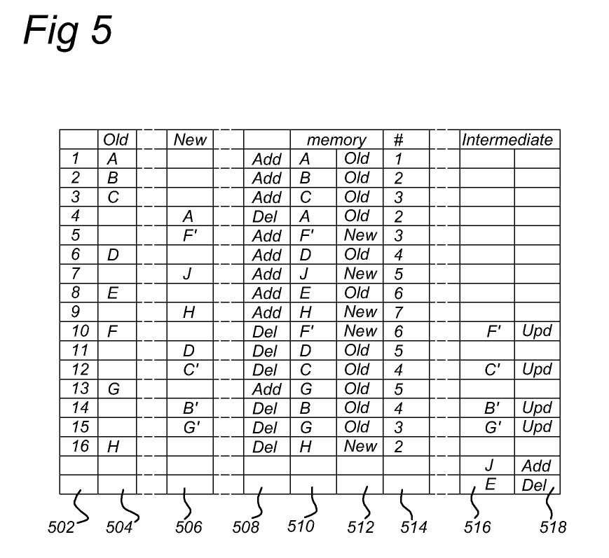

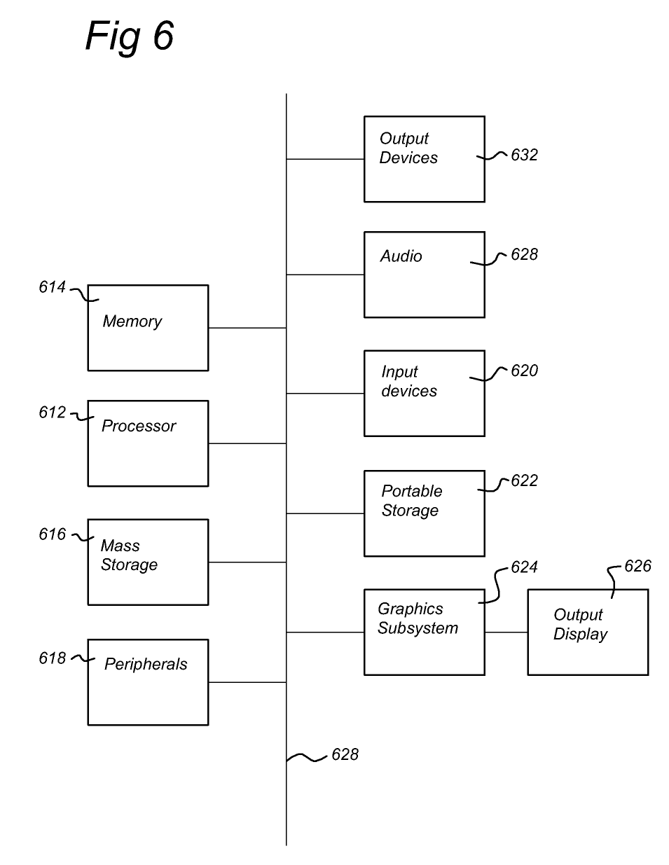

The tables in FIG. 5 are used to illustrates the principle of the approach to perform the comparing of databases according to the invention. Each row in FIG. 5 illustrates the actions performed upon reception of a data set from either the source database or the previous source database. Data sets from the source database are new data sets and data sets from the previous source database are old data sets. The numbers in the first column 502 represent the total number of data sets received. The letters in second column 504 represent the retrieval of an old data set or previous data set from the previous source database and the letters in the third column 506 represent the retrieval of a new data set from the previous source database. The fourth and fifth column 508, 510 represent the action performed on a memory regarding a corresponding data set, after reception of a data set. The data in the sixth column 512 represents an indication stored in the memory identifying the origin of a data set stored in the memory. The numbers in the seventh column 514 indicate the number of data sets stored in the memory after processing of a retrieved data set. The letters in the eighth column 516 represent the data sets stored in the intermediate or difference source data set and the indication in the last column indicate the action to be performed on the target database after receiving the corresponding difference source data set.

First is retrieved an old data set A of a first type from the previous source database. The previous source data base is stored on a data storage medium accessible by the processor performing the method of comparing databases. Subsequently, the memory, which is initially empty, is searched whether a corresponding new data set is stored in the memory. As the memory is empty the corresponding new data set is not found and data set A is added to the memory together with an indication that data set A originates from the previous source database. The number of data sets stored in the memory is now 1. The second row discloses the actions performed after receiving the second data set. The data set B originates again from the previous source database. The corresponding new data set is not found in the memory and consequently data set B is added to the memory with the corresponding indication of origin. Now, the number of data sets is 2 in the memory. Subsequently, a data set C is retrieved from the previous source data base, not found and stored in the memory. The memory comprises now three data sets. The fourth data set is data set A from the source database. The corresponding data set A from the previous source database is found in the memory. As during an synchronization or update cycle a data set is read from a database only once, as soon as a corresponding data set is found in the memory, it can be concluded that the content of the data set has been changed or not. Therefore, data set A originating from the previous source database is deleted from the memory, as a corresponding data set will not be read from the source data set or previous source data set. The number of data sets is reduced to two.

Subsequently, new data set F′ is retrieved. The accent sign indicates that the content of the data set has been changed. The corresponding data set F has not yet been read from the previous source data base and therefore the new data set F′ is added to the memory. Subsequently, previous data set D, new data set J, previous data set E and new data set H have been retrieved and added to the memory. At this stage the number of data sets stored in the memory is seven.

Then previous data set F is retrieved from the previous source database. The corresponding data set F′ is found in the memory. The content of the data sets F and F′ differs and therefore the data set retrieved from the source data set is supplied as a difference source data set and stored in an intermediate database. Furthermore, the corresponding data set stored in the memory, in the present case F′ is deleted from the memory. In an embodiment, each data set in the difference database comprises an indication 518 indicating that the content of the data set is updated. Other indications could be that the data set should be added or deleted in the target database. The indication will be used to perform the corresponding actions on the target database when the content of the intermediate database is supplied to a target system to enable updating of the target database. If the intermediate database is in the form of an XML file or the like, the data sets could be grouped together on the action to be performed. A header preceding the data of a group indicates then the action to be performed on the target database.

Then new data set D is retrieved. The corresponding data set D will be found in the memory and does not differ from the already stored corresponding data set. Therefore, the data set D is deleted from the memory.

Next new data set C′ is retrieved from the source database. The corresponding data set C is found in the memory. The content of the data sets C and C′ differs and therefore the data set retrieved from the source data set is supplied as a difference source data set and stored in the intermediate database. Furthermore, the corresponding data set stored in the memory, in the present case C is deleted from the memory.

Subsequently previous data set G is retrieved from the previous source database. No corresponding data set will be found in the memory, and consequently data set G is added to the memory. Then new data set B′ is retrieved from the source database. Corresponding data set B will be found. As the content of data set B′ differs from data set B, new data set B′ is added to the intermediate database to gather with the update indication, and data set B is deleted from the memory. Similarly after retrieving new data set G′, new data set G′ is added to the intermediate database to gather with the update indication, and data set G is deleted from the memory. Currently, three data sets are still stored in the memory, namely J, E and H.

Finally the last data set H is retrieved from the previous database. Corresponding data set H is found. As the content is similar, data set H is deleted from the memory. As all data set are retrieved from both the previous database and new database, the data sets still available didn't have a corresponding data set in neither the previous source database nor the new source database. The data sets originating from the new source database having the indicator “new” will be added to the intermediate database with the indication “Add” and the data set originating from the previous database will be added to the intermediate database with the indication 518 “Delete”.

The example above already makes clear that the method of comparing databases needs less memory then reading first one of the databases completely in memory and subsequently comparing with the other database. It has been found that when retrieving large databases the order of retrieval of the data sets varies, but not to much. Generally it could be said that for most data sets the sequence number of retrieval varies with a value corresponding to 10% of the total number of data sets in the database.

FIG. 6 illustrates a high level block diagram of a computer system which can be used to implement the method according to the invention.

The computer system of FIG. 6 includes a processor unit 612 and main memory 614. Processor unit 612 may contain a single microprocessor, or may contain a plurality of microprocessors for configuring the computer system as a multi-processor system. Main memory 614 stores, in part, instructions and data for execution by processor unit 612. If the method of the present invention is wholly or partially implemented in software, main memory 614 stores the executable code when in operation. Main memory 614 may include banks of dynamic random access memory (DRAM) as well as high speed cache memory.

The system of FIG. 6 further includes a mass storage device 616, peripheral device(s) 618, input device(s) 620, portable storage medium drive(s) 622., a graphics subsystem 624 and an output display 626. For purposes of simplicity, the components shown in FIG. 6 are depicted as being connected via a single bus 628. However, the components may be connected through one or more data transport means. For example, processor unit 612 and main memory 614 may be connected via a local microprocessor bus, and the mass storage device 616, peripheral device(s) 618, portable storage medium drive(s) 622, and graphics subsystem 624 may be connected via one or more input/output (I/O) buses. Mass storage device 616, which may be implemented with a magnetic disk drive or an optical disk drive, is a non-volatile storage device for storing data, such as the previous source data sets, the different source data, transformed data set, intermediate data sets, and instructions for use by processor unit 612. In one embodiment, mass storage device 616 stores the system software for implementing the present invention for purposes of loading to main memory 614.

Portable storage medium drive 622 operates in conjunction with a portable non-volatile storage medium, such as a floppy disk, micro drive and flash memory, to input and output data and code to and from the computer system of FIG. 6. In one embodiment, the system software for implementing the present invention is stored on such a portable medium, and is input to the computer system via the portable storage medium drive 622. Peripheral device(s) 618 may include any type of computer support device, such as an input/output (I/O) interface, to add additional functionality to the computer system. For example, peripheral device(s) 618 may include a network interface card for interfacing computer system to a network, a modem, etc.

Input device(s) 620 provide a portion of a user interface. Input device(s) 620 may include an alpha-numeric keypad for inputting alpha-numeric and other key information, or a pointing device, such as a mouse, a trackball, stylus, or cursor direction keys. In order to display textual and graphical information, the computer system of FIG. 6 includes graphics subsystem 624 and output display 626.

Output display 626 may include a cathode ray tube (CRT) display, liquid crystal display (LCD) or other suitable display device. Graphics subsystem 624 receives textual and graphical information, and processes the information for output to display 626. Output display 626 can be used to report the results of the processing power needed to perform the method according to the invention, display confirming information indicating which databases are currently being processed and/or display other information that is part of a user interface. The system of FIG. 4 also includes an audio system 728, which includes a microphone. In one embodiment, audio system 728 includes a sound card that receives audio signals from the microphone. Additionally, the system of FIG. 6 includes output devices 632. Examples of suitable output devices include speakers, printers, etc.

The components contained in the computer system of FIG. 6 are those typically found in general purpose computer systems, and are intended to represent a broad category of such computer components that are well known in the art.

Thus, the computer system of FIG. 6 can be a personal computer, workstation, minicomputer, mainframe computer, etc. The computer can also include different bus configurations, networked platforms, multi-processor platforms, etc. Various operating systems can be used including UNIX, Linux, Solaris, Windows, Macintosh OS, and other suitable operating systems.

The method according to the invention enables to merge a diversity of data and solves at least the following problems:
different partners deliver different number of XML files, representing the content of their respective database;
different partners supply different structures within their XML files, due to the different content in the database;
different types of information from each partner;
information in different languages;
data to be shared is considerably large in size;
data from a partner has to be combined with data already available;
static and dynamic data are closely related.

The foregoing detailed description of the invention has been presented for purposes of illustration and description. It is not intended to be exhaustive or to limit the invention to the precise form disclosed, and obviously many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1-12. (canceled)

13. A method for synchronization of source data sets of a source database stored on a source system with representative target data sets in a target database stored on a target system, the source data sets being of a first type and the target data sets being of a second type, the method comprising:
(a) retrieving source data sets;
(b) retrieving previous source data sets from a first memory;
(c) comparing the source data sets with the previous source data sets to obtain difference source data sets of the first type;
(d) replacing in said first memory the previous source data sets with the source data sets;
(e) transforming the difference source data sets into transformed data sets of the second type;
(f) supplying the transformed data sets to the target system to enable updating of the representative target data sets.

14. The method according to claim 13, wherein the method further comprises repeatedly performing the actions.

15. The method according to claim 13, wherein the transforming action (e) comprises:
(e1) converting the difference source data sets into intermediate data sets of a third type;
(e2) retrieving data from the intermediate data sets to obtain the transformed data set.

16. The method according to claim 15, wherein the data sets of the third type comprises data fields for storing a representation of at least a part of the data fields of a data set of the first type and data fields representative for data fields of a data set of the second type.

17. The method according to claim 15, wherein the data sets of the third type comprises a data field with content being a copy of content of a data field of the source data set and a data field with content being a representation of said content of said data field of the source data set.

18. The method according to claim 13, wherein comparing (c) comprises:
(c1) retrieving a new data set of the first type from the source database;
(c2) searching for a corresponding previous data set stored in a second memory;
(c3) if a corresponding previous data set is not found in (c2) storing the new data set from the source database in the second memory;
(c4) if a corresponding previous data set is found in (c2) perform:
(c4a) supplying a difference source data set obtained from the new data set if the new data set differs from the corresponding previous data set; and
(c4b) removing corresponding previous data set from second memory.

19. The method according to claim 18, wherein comparing (c) comprises:
(c5) retrieving a previous data set of the first type from the previous source database;
(c6) searching for a corresponding new data set stored in the second memory;
(c7) if a corresponding new data set is not found in (c6) storing the corresponding previous data set from the first in the second memory;
(c8) if a corresponding previous data set is found in (c6) perform:
(c8a) supplying a difference source data set obtained from the new data set if the new data set differs from the corresponding previous data set; and
(c8b) removing corresponding new data set from second memory.

20. The method according to claim 13 comprising:
(g) controlling the actions (a) and (b) in dependence of the number of retrieved new source data sets and the number of retrieved previous source data sets.

21. The method according to claim 13, wherein a source data set comprises a static data part and a dynamic data part, and the actions (a)-(f) being performed independently for the static data part and the dynamic data part.

22. The method as claimed in claim 21, wherein a difference source data set corresponding to a dynamic data part comprises a status indication flag, wherein transforming (f) of a difference source data set corresponding to a dynamic data part is performed under control of the status indication flag.

23. A computer program product in a processor readable storage medium, comprising computer executable instructions which instructions when executed on at least one processor perform the method comprising:
(a) retrieving source data sets;
(b) retrieving previous source data sets from a first memory;
(c) comparing the source data sets with the previous source data sets to obtain difference source data sets of the first type;
(d) replacing in said first memory the previous source data sets with the source data sets;
(e) transforming the difference source data sets into transformed data sets of the second type;
(f) supplying the transformed data sets to the target system to enable updating of the representative target data sets.

24. A computing system for synchronization of source data sets of a source database with representative target data sets in a target database, the computing system comprising:
input means (302) for receiving source data sets from a source system;
at least one processor (318) for generating a transformed data sets;
a processor readable storage medium (312) comprising executable instructions which instructions when executed on said at least one processor perform the method comprising:
(a) retrieving source data sets;
(b) retrieving previous source data sets from a first memory;
(c) comparing the source data sets with the previous source data sets to obtain difference source data sets of the first type;
(d) replacing in said first memory the previous source data sets with the source data sets;
(e) transforming the difference source data sets into transformed data sets of the second type;
(f) supplying the transformed data sets to the target system to enable updating of the representative target data sets;
output means (308) for supplying the transformed data sets to a target system to enable updating of the representative target data sets.
